(19) United States
(12) Patent Application Publication
(10) Pub. No.: US 2006/0266802 A1
(43) Pub. Date: Nov. 30, 2006

(54) SOLID WIRE FOR GAS SHIELDED ARC WELDING

(75) Inventor: Yong Chul Kim, Changwon (KR)

Correspondence Address: SQUIRE, SANDERS & DEMPSEY L.L.P, 600 HANSEN WAY, PALO ALTO, CA, 94304-1043, US

(73) Assignee: KISWEL LTD., SASANG-GUBUSAN (KR)

(21) Appl. No.: 11/381,988

(22) Filed: May 5, 2006

(30) Foreign Application Priority Data
May 25, 2005 (KR) 10-2005-0043935

(51) Int. Cl. A47J 36/02

(52) U.S. Cl. 228/101

(57) ABSTRACT

Disclosed is a solid wire for gas shielded arc welding treated with a surface treatment soil which includes metal salts containing Sodium (Na), potassium (K), calcium (Ca) and zinc (Zn), and a non-metal phosphorus (P), and a hydrocarbon compound containing at least two functional groups selected from the group that consists of ester, carboxylic acid and alkane groups. According to the present invention, the solid wire treated with a specific liquid surface treatment agent exhibited superior rust resistance and wire feedability to those of conventional solid wires.

### BACKGROUND OF THE INVENTION

1. Field of the Invention

The present invention relates in general to a solid wire for gas shielded arc welding, and more particularly, to a welding wire surface treated with the surface treatment oil which can provide good rust resistance and wire feedability to the welding wire.

2. Description of the Related Art

In general, a solid wire for gas shielded arc welding is used in diverse types of products requiring a spool of wire or a pail pack of wire in winding unit. These products, however, are manufactured and then spent past an extended period of time until they are actually used by consumers. Therefore, it is necessary to manufacture a solid wire that has anti-rust property, i.e., good rust resistance.

Moreover, a gas shielded arc welding solid wire used in high-efficiency and robot welding requires smooth wire feedability. Especially if a welding cable is long and much indented and is used under rough welding environment (e.g., high-current and high-voltage condition), good wire feedability is an absolute requirement.

Depending on manufacturing methods, solid wires for gas shielded arc welding are largely divided into two types.

One of them is a copper-coated solid wire. The surface of the copper-coated solid wire is coated with a copper-plating layer in order to ensure good electric conductivity (or current-carrying stability), rust resistance (or corrosion resistance), and wire feedability. However, these qualities are obtained only when the plating layer is dense and has a uniform thickness.

Unfortunately, in practice, it is impossible to obtain such a perfect plating layer from the in-line mass production system which is quite different from the perfect environment of a copper plating tank provided to an experiment chamber.

When the copper plating does not have a uniform thickness, the plating layer flakes off within a conduit cable during the actual welding process, and the flaked plating layer is accumulated in the conduit cable, resulting in interfering with feedability. This non-uniform plating layer deteriorates rust resistance and causes rust to form on the surface of the wire.

The other is a non-copper-coated solid wire.

Unlike the copper-coated solid wire, the non-copper-coated solid wire needs a stable surface coating layer attached to the surface instead of the role of the copper-coating layer. This surface coating layer provides rust resistance and wire feedability to the non-copper-coated wire.

However, since the steel base of the non-plated (Copper-free) wire is exposed to the air, the formation of rust on the surface is inevitable. Especially, a non-uniform surface coating layer of the copper free wire not only is sensitive to the formation of rust but also increases the load of feedability due to the friction in a conduit cable during the actual welding process.

To resolve these problems of copper-coated and copper-free wires, researches on wire surface and development of surface treatment agents have been made to date.

First of all, there are various surface treatment agents for solid wires in general. For example, Japanese Patent Application Laid-Open Publication Nos. Hei 11-147194 and Hei 11-147195 disclose a technique using surface treatment agents for improving wire feedability. In detail, lubricating oil made of hydrocarbon compounds which have from 5 to 12 carbon atoms is applied to the surface of a wire, and the lubricating oil and lubricating particles are chemically bonded together.

In addition, Japanese Patent Application Laid-Open Publication No. Hei 6-262389 discloses a technique for improving wire feedability by coating the surface of a wire with a rust inhibitor, anti-rust lubricant which uses lubricating oil as base oil and which contains 5-30% of organic molybdenum compound.

Japanese Patent Application Laid-Open Publication No. Hei 8-281471 discloses a technique for improving wire feedability by coating the surface of a wire with a lubricant which uses lubricating oil as base oil and which contains 2-40% of chlorocarbon.

Secondly, there are surface treatment agents for copper-coated solid wires. For example, Japanese Patent Application Laid-Open Publication No. Hei 1-166899 discloses a technique for ensuring wire feedability by coating the surface of a wire with a lubricant formed by dispersing higher fatty acid metallic salt or a mixture of the higher fatty acid metallic salt with higher fatty acid in mineral oil.

In addition, Japanese Patent Application Laid-Open Publication No. Hei 2-284792 discloses a technique for improving wire feedability and rust resistance by applying an oily lubricant containing a potassium or sodium salts of carboxylic acids to the surface of a wire.

Thirdly, there are surface treatment agents for non-copper-coated solid wires. For example, Japanese Patent Application Laid-Open Publication No. S55-141395 discloses a technique for improving rust resistance by coating the surface of a wire with a mixture of powder sulfur, MoS₂ and graphite.

Moreover, Japanese Patent Application Laid-Open Publication No. Hei 11-147174 discloses a technique for improving wire feedability by spreading MoS₂ to the surface of a wire.

Also, Japanese Patent Application Laid-Open Publication No. S58-090397 discloses a technique for ensuring wire feedability and rust resistance by coating the surface of a wire with a thin film of paraffin.

Japanese Patent Application Laid-Open Publication Nos. S58-135795 and S58-184095 disclose a technique for improving wire feedability by using a solid surface treatment agent, e.g., graphite and MoS₂, respectively.

Further, Japanese Patent Application Laid-Open Publication No. 2001-252786 discloses a technique for improving wire feedability by using a mixture of a liquid surface treatment agent and the above-described solid surface treatment agent.

Those conventional surface treatment agents contain lubricating particles or powder-like solid lubricants on the basis of lubricating oil as base oil.

As another example, surface treatment agents may contain a powder-like solid lubricant such as MoS₂ or graphite, or a mixture of this or these solid lubricants and the liquid lubricant.

However, the surface treatment agents containing a powder-like solid lubricant have problems as follows:

(1) When a wire is fed for an extended period of time, the solid lubricant is accumulated in a conduit cable and causes deteriorations in wire feedability;

(2) The solid lubricant has an inferior rust resistance to the liquid lubricant;

(3) When applied to the circumferential surface of a wire, the solid lubricant absorbs moisture in the air and slightly increases the amount of hydrogen in a weld metal for welding; and

(4) A solid lubricant containing a carbon group increases the amount of fume.

### SUMMARY OF THE INVENTION

It is, therefore, an object of the present invention to provide an appropriate liquid surface treatment agent for a solid wire for gas shielded arc welding, which provides good rust resistance and wire feedability to the wire without damaging wire weldability.

The above object was achieved by developing a homogeneous liquid surface treatment agent containing metallic salts and a nonmetallic chemical element such as phosphorus in hydrocarbon compounds.

By spreading this homogeneous liquid surface treatment agent to a specific range of a wire for welding, rust resistance and wire feedability of a solid wire for gas shielded arc welding can be improved.

In accordance of a first aspect of the present invention, there is provided a solid wire for gas shielded arc welding treated with a surface treatment oil including: metal salts containing Sodium (Na), potassium (K), calcium (Ca) and zinc (Zn), and a non-metal phosphorus (P), and a hydrocarbon compound containing at least two functional groups selected from the group that consists of ester, carboxylic acid and alkane groups.

In accordance of a second aspect of the present invention, there is provided a solid wire treated with the surface treatment agent of the first invention, wherein, if converted into metal elements, respectively, the surface treatment oil comprises metal salts containing 0.05-0.85 wt % of Na+Ca, 0.05-0.70 wt % of K and 0.02-0.55 wt % of Zn, 0.10-0.80 wt % of P, and 97.10-99.78 wt % of the hydrocarbon compound containing at least two functional groups selected from the group that consists of ester, carboxylic acid and alkane groups, with respect to a total weight of the surface treatment oil.

In accordance of a third aspect of the present invention, there is provided a solid wire treated with the surface treatment oil according to the first or the second invention, wherein the surface treatment oil is applied to the wire surface in an amount of 0.03-0.60 g per 1 kg of a wire for welding.

### DETAILED DESCRIPTION OF THE PREFERRED EMBODIMENTS

The present invention will now be described in detail. First, functions of each component constituting the surface treatment oil and their addition methods according to the present invention will be explained.

A Na salt used in the invention is firmly adsorbed to the surface of a wire to form an anti-rust film, thereby functioning to prevent the formation of rust on the wire surface. A preferred Na salt is a sodium sulfonate represented by [RSO₃]Na.

A K salt used in the invention plays a role in lowering the ionization voltage during the welding process to ensure arc stability and smooth wire feedability. A preferred K salt is a potassium carboxylate represented by C₇H₁₅COOK.

Similar to the Na salt, a Ca salt used in the invention is firmly adsorbed to the surface of a wire to form an anti-rust film, thereby preventing the formation of rust on the wire surface. A preferred Ca salt is a Ca sulfonate represented by [RSO₃]₂Ca.

A Zn salt used in the invention forms a protective film on the surface of a wire for welding to prevent the wire surface from being scratched when passing through a conduit cable, thereby realizing the smooth wire feedability. A preferred Zn salt is a zinc phosphate represented by RO₄[P₂S₄]Zn.

A nonmetallic component, phosphorus used in the invention is used in form of phosphate ester. The phosphate ester is adsorbed to the surface of a wire and provides a low coefficient of friction between metals. In other words, the phosphorus plays a role in providing the wire with wire feedability during the welding process.

A hydrocarbon compound containing at least two functional groups is used in the invention, in which the functional groups are selected from an ester group, a carboxylic acid group and an alkane group. The hydrocarbon compound is adsorbed to the surface of a wire, and serves to substantially lower the surface energy and to provide a low coefficient of friction between metals. In addition, they form a homogeneous liquid coat on the surface of the wire and improve rust resistance and lubricant property.

Such hydrocarbon compound is at least one or more material selected from the group consisting of wool fats, wool waxes, lanolins, stearic acid, oleic acid, dimer acids, adipic acid, dicarboxylic acids esters, polyol esters, complex esters, phosphate esters, slack waxes, scale waxes, semi-refined paraffin waxes and micro crystalline waxes.

The following now explains the reason for limiting the content of each component of the surface treatment oil according to the present invention. The content of a component is expressed in percentage with respect to the total weight of the surface treatment oil.

(1) Na+Ca: 0.05-0.85 wt %

Na and Ca are added in form of Na sulfonate and Ca sulfonate, respectively. If the content of these two components after their converted to metal elements are contained less than 0.05 wt % in the surface treatment oil, rust resistance is deteriorated. And, if the content of these two components after their converted to metal elements are contained more than 0.85 wt % in the surface treatment oil, the adsorbability of the wire surface is deteriorated and thus, good rust resistance cannot be ensured.

(2) K: 0.05-0.70 wt %

K is added in form of carboxylic acid potassium salt. If the content after its converting to a metal element is less than 0.05 wt % in the surface treatment oil, it fails to lower the ionization voltage during the welding process. Consequently, arc becomes unstable and this results in the deterioration of wire feedability. If the content is greater than 0.70 wt %, it also fails to contribute to stabilizing the arc and providing smooth wire stability.

(3) Zn: 0.02-0.55 wt %

Zn is added in form of Zn phosphate. If the content after its converting to a metal element is less than 0.02 wt % in the surface treatment oil, a protective film is not formed on the surface of the wire and as a result thereof, the surface of wire is easily scratched during the welding process. On the other hand, if the content is greater than 0.55 wt %, viscosity of the surface treatment oil is increased, thereby making it difficult to obtain a homogeneous liquid coat.

(4) P: 0.10-0.80 wt %

P is added in form of phosphate ester. If the content after its converting to a P element is less than 0.10 wt % in the surface treatment oil, the adsorbability of the surface treatment oil on the wire surface is deteriorated and this in turn fails to improve wire feedability. On the other hand, if the content is greater than 0.80 wt %, viscosity of the surface treatment oil is rapidly increased, thereby making it very difficult to obtain a homogeneous liquid coat. Therefore, it fails to improve wire feedability.

(5) Hydrocarbon compound: 97.10-99.78%

Hydrocarbon compound used in the invention has at least two functional groups selected from the group consisting of ester, carboxylic acid and alkane groups, and dissolves metal salts in the surface treatment oil. Its major role is to form a firm rust-resistant film and a homogeneous liquid coat on the surface of the wire. A preferable content thereof is in a range from 97.10 to 99.78 wt % in order to contribute good rust resistance and wire feedability of the wire.

The above-described contents of each component were obtained by the following analysis method.

The quantitative analyses of Na, Ca, K, Zn and P are done as follows.

1. Put 0.05-0.1 g of sample in a 250 ml beaker and add 10 ml of sulfuric acid.

2. Place the beaker on a hot plate at 350° C. or higher to cause a reaction of pyrolysis, and cool to room temperature.

3. Add 10 ml of hydrochloric acid and nitric acid at the mixture ratio of 3:1, and heat the mixture again on the hot plate and cool to room temperature.

4. Filter the cooled mixture by a high-purity quantitative filter paper No. 5B, and pour the filtrate into a 100 ml measuring flask to use it as a measurement sample.

5. Carry out a quantitative analysis with ICP-AES.

Here, ICP-AES is an abbreviation for Inductively Coupled Plasma Atomic Emission Spectrometer. As for the measurement, IRIS advantage device manufactured by Thermo Elemental Company was used.

In addition, the functional group of the hydrocarbon compound can be analyzed by an infrared spectrophotometer.

The following now describe how to apply or spread the surface treatment oil on the wire for welding.

Table 1 illustrates the compositions of wires for welding. In detail, a copper-coated solid wire and a copper-free solid wire, YGW11 and YGW12, defined by JIS Z3312 were manufactured to 1.2 mm in diameter and were treated with the surface treatment oil of the present invention. The remainder of the composition in Table 1 consists of Fe and inevitable impurities.

The surface treatment oil may be applied to the wire surface by using a felt or the electrostatic oil coating method, or the wire may be immersed in the surface treatment oil and a proper amount of the oil may be removed from the wire surface later.

TABLE 1

| | | Wire composition (wt %) | | | | | | |
|---|---|---|---|---|---|---|---|---|
| Spec | Type | C | Si | Mn | P | S | Cu | Ti |
| YGW11 | CC | 0.05 | 0.88 | 1.52 | 0.012 | 0.006 | 0.25 | 0.19 |
| | CF | 0.06 | 0.79 | 1.57 | 0.016 | 0.011 | 0.01 | 0.16 |
| YGW12 | CC | 0.06 | 0.86 | 1.50 | 0.018 | 0.009 | 0.23 | — |
| | CF | 0.07 | 0.85 | 1.52 | 0.014 | 0.012 | 0.01 | — |

*CC: Copper coated wire
**CF: Copper free wire

There is a reason why the surface treatment oil application amount is limited.

For instance, if the oil application amount is less than 0.03 g per 1 kg of a wire, which is too little, load on wire feedability in a conduit cable to be fed is increased during the welding process.

In addition, if the surface treatment oil application amount is more than 0.60 g per 1 kg of a wire, which is too much, a slip problem occurs in a wire feeder, thereby making it difficult to ensure smooth wire feedability.

The surface treatment oil application amount was measured as follows.

1. Cut a wire in 4-6 cm long, and prepare 50-80 g of such wires.

2. Weigh the wires by a pair of scales (1 g/10000) to get the weight (Wb) before degreasing (to four decimal points).

3. Put 150 ml of CCl₄ into a 250 ml beaker.

4. Place the wires in the beaker with CCl₄ and carry out the ultrasonic degreasing process for 10 minutes.

5. Dry the degreased wires in a dry oven for 10 minutes and cool to room temperature in a desiccator.

6. Weigh the dried wires by a pair of scales (1 g/10000) to get the weight (Wa) after degreasing (to four decimal points).

7. Calculate the surface treatment oil application amount based on the measured Wb and Wa values using the following equation.
Surface treatment oil application amount=(g/w●kg)={(Wb−Wa)/Wa}×1000 [Equation 1]

The surface treatment oil of the present invention was applied to the wires of Table 1 for comparison (e.g., Example and Comparative examples).

The following now explains the measurement method of rust resistance and wire feedability, which are major advantages achieved by the present invention.

I. Rust-Resistance

Salt water spray test conditions were set as shown in Table 2 and 60 minutes later rust formation on the wire surface was observed. If rust was observed on the wire surface rust resistance was indicated by ‘X‘, while rust was not observed rust resistance was indicated by ‘O’.

TABLE 2

| | Chamber | | |
|---|---|---|---|
| Salt water | temperature | Tank | Salt water spray |
| concentration | (° C.) | temperature (° C.) | pressure |
| NaCl 5% | 35 | 50 | 0.15 Mpa |

Wire feedability test conditions were set as shown in Table 3 to evaluate and grade wire feedability.

When the wire feeding was interrupted for less than 100 seconds and thus, an arc is stopped, the wire feedability was indicated by ‘X’. On the other hand, when continuous welding was possible for 100 seconds or longer, the wire feedability was indicated by ‘O’.

As aforementioned, the diameter of the wires used here was 1.2 mm.

TABLE 3

| Welding conditions | | Gas conditions | | Other conditions | |
|---|---|---|---|---|---|
| Current (A) | 420 | Kind | CO₂ | Conduit | New 5 m-long |
| Voltage (V) | 44 | | 100% | cable | 2 turn feed |
| | | | | | cable (300 mm |
| | | | | | in diameter) |
| Welding | 50 | Gas flow | 20 | Welding | Zigzag |
| speed | | rate (1/min) | | type | weaving |
| (cm/min) | | | | | welding |
| | | | | | upon bead- |
| | | | | | on-plate |

TABLE 4a

| | | | | | | | Hydrocarbon | | | | | Oil | | |
|---|---|---|---|---|---|---|---|---|---|---|---|---|---|---|
| | | Kind | Conversion value of | | | P | compound | | | | Surface | application | | |
| | | of | metal salt (wt %) | | | (wt | | Carboxylic | | Total | treatment | amount | | |
| Item | No. | wire | Na + Ca | K | Zn | %) | Ester | acid | Alkane | (wt %) | oil (wt %) | (g/w · kg) | RR | WF |
| COMPARATIVE EX | 1 | CF* | 0.65 | 0.65 | 0.07 | 0.14 | ◯ | — | — | 98.49 | 100.00 | 0.15 | X | X |
| | 2 | CF | 0.38 | 0.32 | 0.10 | 0.22 | — | — | ◯ | 98.98 | 100.00 | 0.35 | X | X |
| | 3 | CC** | 0.21 | 0.17 | 0.22 | 0.66 | — | ◯ | — | 98.74 | 100.00 | 0.51 | X | X |
| | 4 | CF | 0.86 | 0.15 | 0.55 | 0.52 | ◯ | ◯ | — | 97.92 | 100.00 | 0.03 | X | ◯ |
| | 5 | CC | 0.03 | 0.05 | 0.26 | 0.80 | ◯ | ◯ | — | 98.86 | 100.00 | 0.09 | X | ◯ |
| | 6 | CC | 0.88 | 0.38 | 0.16 | 0.61 | ◯ | — | ◯ | 97.97 | 100.00 | 0.17 | X | ◯ |
| | 7 | CF | 0.02 | 0.54 | 0.38 | 0.47 | ◯ | — | ◯ | 98.59 | 100.00 | 0.25 | X | ◯ |
| | 8 | CF | 0.91 | 0.34 | 0.29 | 0.17 | — | ◯ | ◯ | 98.29 | 100.00 | 0.38 | X | ◯ |
| | 9 | CF | 0.04 | 0.61 | 0.03 | 0.64 | — | ◯ | ◯ | 98.68 | 100.00 | 0.54 | X | ◯ |
| | 10 | CC | 0.85 | 0.77 | 0.19 | 0.45 | ◯ | ◯ | — | 97.74 | 100.00 | 0.04 | ◯ | X |
| | 11 | CC | 0.57 | 0.02 | 0.49 | 0.41 | ◯ | ◯ | — | 98.51 | 100.00 | 0.11 | ◯ | X |
| | 12 | CF | 0.11 | 0.73 | 0.25 | 0.26 | ◯ | — | ◯ | 98.65 | 100.00 | 0.18 | ◯ | X |
| | 13 | CF | 0.44 | 0.04 | 0.40 | 0.73 | ◯ | — | ◯ | 98.39 | 100.00 | 0.28 | ◯ | X |
| | 14 | CC | 0.79 | 0.71 | 0.54 | 0.38 | — | ◯ | ◯ | 97.58 | 100.00 | 0.42 | ◯ | X |
| | 15 | CC | 0.25 | 0.02 | 0.02 | 0.29 | — | ◯ | ◯ | 99.42 | 100.00 | 0.57 | ◯ | X |
| | 16 | CF | 0.71 | 0.21 | 0.56 | 0.10 | ◯ | ◯ | — | 98.42 | 100.00 | 0.06 | ◯ | X |

*CF: Copper free wire
**CC: Copper coated wire
RR: Rust resistance
WF: Wire feedability

TABLE 4b

| | | | | | | | Hydrocarbon | | | | | Oil | | |
|---|---|---|---|---|---|---|---|---|---|---|---|---|---|---|
| | | Kind | Conversion value of | | | P | compound | | | | Surface | application | | |
| | | of | metal salt (wt %) | | | (wt | | Carboxylic | | Total | treatment | amount | | |
| Item | No. | wire | Na + Ca | K | Zn | %) | Ester | acid | Alkane | (wt %) | oil (wt %) | (g/w · kg) | RR | WF |
| COMPARATIVE EX | 17 | CF* | 0.07 | 0.51 | 0.01 | 0.55 | ◯ | ◯ | — | 98.86 | 100.00 | 0.12 | ◯ | X |
| | 18 | CC** | 0.53 | 0.06 | 0.59 | 0.32 | ◯ | — | ◯ | 98.50 | 100.00 | 0.21 | ◯ | X |
| | 19 | CC | 0.05 | 0.57 | 0.01 | 0.70 | ◯ | — | ◯ | 98.67 | 100.00 | 0.30 | ◯ | X |
| | 20 | CF | 0.68 | 0.44 | 0.62 | 0.35 | — | ◯ | ◯ | 97.91 | 100.00 | 0.44 | ◯ | X |
| | 21 | CF | 0.74 | 0.70 | 0.01 | 0.78 | — | ◯ | ◯ | 97.77 | 100.00 | 0.59 | ◯ | X |
| | 22 | CF | 0.32 | 0.47 | 0.04 | 0.85 | ◯ | ◯ | — | 98.32 | 100.00 | 0.08 | ◯ | X |
| | 23 | CC | 0.84 | 0.29 | 0.33 | 0.09 | ◯ | ◯ | — | 98.45 | 100.00 | 0.14 | ◯ | X |
| | 24 | CF | 0.48 | 0.11 | 0.13 | 0.84 | ◯ | — | ◯ | 98.44 | 100.00 | 0.23 | ◯ | X |
| | 25 | CC | 0.06 | 0.25 | 0.43 | 0.07 | ◯ | — | ◯ | 99.19 | 100.00 | 0.32 | ◯ | X |
| | 26 | CC | 0.16 | 0.40 | 0.35 | 0.81 | — | ◯ | ◯ | 98.28 | 100.00 | 0.47 | ◯ | X |
| | 27 | CF | 0.83 | 0.08 | 0.51 | 0.03 | — | ◯ | ◯ | 98.55 | 100.00 | 0.60 | ◯ | X |
| | 28 | CF | 0.06 | 0.05 | 0.04 | 0.14 | ◯ | ◯ | — | 99.71 | 100.00 | 0.61 | ◯ | X |
| | 29 | CC | 0.44 | 0.35 | 0.31 | 0.47 | ◯ | — | ◯ | 98.43 | 100.00 | 0.02 | ◯ | X |
| | 30 | CC | 0.85 | 0.65 | 0.53 | 0.76 | ◯ | ◯ | — | 97.21 | 100.00 | 0.63 | ◯ | X |
| | 31 | CF | 0.26 | 0.46 | 0.28 | 0.45 | — | ◯ | ◯ | 98.55 | 100.00 | 0.01 | ◯ | X |

*CF: Copper free wire
**CC: Copper coated wire
RR: Rust resistance
WF: Wire feedability

TABLE 4c

| | | | | | | | Hydrocarbon | | | | | Oil | | |
|---|---|---|---|---|---|---|---|---|---|---|---|---|---|---|
| | | | Conversion value of | | | P | compound | | | | Surface | application | | |
| | | | metal salt (wt %) | | | (wt | | Carboxylic | | Total | treatment | amount | | |
| Item | No. | Kind of wire | Na + Ca | K | Zn | %) | Ester | acid | Alkane | (wt %) | oil (wt %) | (g/w · kg) | RR | WF |
| EXAMOLES | 1 | CF* | 0.16 | 0.27 | 0.09 | 0.35 | — | ◯ | ◯ | 99.13 | 100.00 | 0.36 | ◯ | ◯ |
| | 2 | CC** | 0.15 | 0.16 | 0.36 | 0.32 | ◯ | — | ◯ | 99.01 | 100.00 | 0.43 | ◯ | ◯ |
| | 3 | CF | 0.28 | 0.13 | 0.07 | 0.18 | ◯ | ◯ | — | 99.34 | 100.00 | 0.52 | ◯ | ◯ |
| | 4 | CF | 0.11 | 0.25 | 0.05 | 0.15 | ◯ | — | ◯ | 99.44 | 100.00 | 0.60 | ◯ | ◯ |
| | 5 | CC | 0.09 | 0.09 | 0.38 | 0.12 | ◯ | — | ◯ | 99.32 | 100.00 | 0.25 | ◯ | ◯ |
| | 6 | CF | 0.05 | 0.07 | 0.03 | 0.10 | — | ◯ | ◯ | 99.75 | 100.00 | 0.18 | ◯ | ◯ |
| | 7 | CC | 0.06 | 0.05 | 0.02 | 0.30 | — | ◯ | ◯ | 99.57 | 100.00 | 0.11 | ◯ | ◯ |
| | 8 | CF | 0.43 | 0.55 | 0.42 | 0.58 | ◯ | ◯ | — | 98.02 | 100.00 | 0.03 | ◯ | ◯ |
| | 9 | CF | 0.77 | 0.40 | 0.32 | 0.66 | — | ◯ | ◯ | 97.85 | 100.00 | 0.34 | ◯ | ◯ |
| | 10 | CF | 0.73 | 0.37 | 0.41 | 0.54 | — | ◯ | ◯ | 97.95 | 100.00 | 0.41 | ◯ | ◯ |
| | 11 | CF | 0.70 | 0.51 | 0.30 | 0.52 | ◯ | — | ◯ | 97.97 | 100.00 | 0.50 | ◯ | ◯ |
| | 12 | CC | 0.42 | 0.36 | 0.27 | 0.62 | ◯ | ◯ | — | 98.33 | 100.00 | 0.59 | ◯ | ◯ |
| | 13 | CC | 0.41 | 0.35 | 0.38 | 0.51 | ◯ | ◯ | — | 98.35 | 100.00 | 0.27 | ◯ | ◯ |
| | 14 | CC | 0.25 | 0.48 | 0.26 | 0.49 | — | ◯ | ◯ | 98.52 | 100.00 | 0.19 | ◯ | ◯ |
| | 15 | CF | 0.63 | 0.34 | 0.25 | 0.47 | ◯ | — | ◯ | 98.31 | 100.00 | 0.13 | ◯ | ◯ |
| | 16 | CF | 0.45 | 0.38 | 0.29 | 0.45 | ◯ | — | ◯ | 98.43 | 100.00 | 0.04 | ◯ | ◯ |

*CF: Copper free wire
**CC: Copper coated wire
RR: Rust resistance
WF: Wire feedability

TABLE 4d

| | | | | | | | Hydrocarbon | | | | | Oil | | |
|---|---|---|---|---|---|---|---|---|---|---|---|---|---|---|
| | | | Conversion value of | | | P | compound | | | | Surface | application | | |
| | | | metal salt (wt %) | | | (wt | | Carboxylic | | Total | treatment | amount | | |
| Item | No. | Kind of wire | Na + Ca | K | Zn | %) | Ester | acid | Alkane | (wt %) | oil (wt %) | (g/w · kg) | RR | WF |
| EXAMPLES | 17 | CF* | 0.84 | 0.70 | 0.53 | 0.80 | ◯ | ◯ | — | 97.13 | 100.00 | 0.31 | ◯ | ◯ |
| | 18 | CC** | 0.47 | 0.67 | 0.55 | 0.79 | ◯ | ◯ | — | 97.52 | 100.00 | 0.39 | ◯ | ◯ |
| | 19 | CC | 0.82 | 0.45 | 0.51 | 0.76 | ◯ | — | ◯ | 97.46 | 100.00 | 0.47 | ◯ | ◯ |
| | 20 | CF | 0.84 | 0.64 | 0.37 | 0.74 | — | ◯ | ◯ | 97.41 | 100.00 | 0.56 | ◯ | ◯ |
| | 21 | CF | 0.67 | 0.62 | 0.48 | 0.60 | — | ◯ | ◯ | 97.63 | 100.00 | 0.28 | ◯ | ◯ |
| | 22 | CC | 0.44 | 0.44 | 0.46 | 0.71 | ◯ | — | ◯ | 97.95 | 100.00 | 0.21 | ◯ | ◯ |
| | 23 | CC | 0.46 | 0.58 | 0.34 | 0.68 | ◯ | ◯ | — | 97.94 | 100.00 | 0.15 | ◯ | ◯ |
| | 24 | CC | 0.38 | 0.36 | 0.24 | 0.28 | — | ◯ | ◯ | 98.74 | 100.00 | 0.06 | ◯ | ◯ |
| | 25 | CF | 0.35 | 0.34 | 0.19 | 0.43 | — | ◯ | ◯ | 98.69 | 100.00 | 0.37 | ◯ | ◯ |
| | 26 | CF | 0.32 | 0.22 | 0.22 | 0.41 | ◯ | — | ◯ | 98.83 | 100.00 | 0.44 | ◯ | ◯ |
| | 27 | CF | 0.21 | 0.31 | 0.20 | 0.39 | ◯ | — | ◯ | 98.89 | 100.00 | 0.55 | ◯ | ◯ |
| | 28 | CC | 0.51 | 0.23 | 0.15 | 0.26 | ◯ | ◯ | — | 98.85 | 100.00 | 0.29 | ◯ | ◯ |
| | 29 | CF | 0.55 | 0.20 | 0.23 | 0.25 | ◯ | ◯ | — | 98.77 | 100.00 | 0.24 | ◯ | ◯ |
| | 30 | CF | 0.59 | 0.18 | 0.12 | 0.37 | ◯ | — | ◯ | 98.74 | 100.00 | 0.16 | ◯ | ◯ |
| | 31 | CF | 0.19 | 0.29 | 0.20 | 0.21 | ◯ | ◯ | — | 99.11 | 100.00 | 0.09 | ◯ | ◯ |

*CF: Copper free wire
**CC: Copper coated wire
RR: Rust resistance
WF: Wire feedability

The following now explains rust resistance and wire feedability of Examples and Comparative examples shown in Table 4 with respect to one embodiment of the present invention.

The wires of the Comparative examples 1-3 have the conversion values of metal salts and the P values within the range of the present invention. However, since the hydrocarbon compound has only one functional group, the wires exhibited poor rust resistance and poor wire feedability.

The wires of the Comparative examples 4-9 have Na+Ca values among the conversion values of metal salts outside the range of the present invention. However, since the other components K, Zn and P are within the range of the present invention and since the hydrocarbon compound has two different functional groups, the wires exhibited good wire feedability.

The wires of the Comparative examples 10-15 have K values among the conversion values of metal salts outside the range of the present invention, so they had poor wire feedability. However, since the components Na+Ca, Zn, and P are within the range of the present invention and since the hydrocarbon compound has two different functional groups, the wires exhibited good rust resistance.

The wires of the Comparative examples 16-21 have Zn values among the conversion values of metal salts outside the range of the present invention, so they had poor wire feedability. However, since the components Na+Ca, K, and P are within the range of the present invention and since the hydrocarbon compound has two different functional groups, the wires exhibited good rust resistance.

The wires of the Comparative examples 22-27 have P values outside the range of the present invention, so they had poor wire feedability. However, since the components Na+Ca, K, and Zn are within the range of the present invention and since the hydrocarbon compound has two different functional groups, the wires exhibited good rust resistance.

The wires of the Comparative examples 28-31 have Na+Ca, K, Zn and P values within the range of the present invention and the hydrocarbon compound has two different functional groups, so the wires exhibited good rust resistance. However, since the surface treatment oil application amounts are outside the range of the present invention, the wires exhibited poor wire feedability.

Especially, since the surface treatment oil application amounts of the Comparative examples 28 and 30 were too much, a slip problem occurred in the wire feeder. Meanwhile, since the surface treatment oil application amounts of the Comparative examples 29 and 31 were too little, frictions of the wires in the cable to be fed were increased and therefore, the wire feedabilities thereof were not good.

On the other hand, the wires of the Examples 1-31 have Na+Ca, K, Zn and P values within the range of the present invention, and the hydrocarbon compound has two different functional groups. Also, since the surface treatment oil application amounts are within the range of the present invention, the wires exhibited good rust resistance and good wire feedability.

As explained so far, having been treated with the homogeneous liquid surface treatment agent having the above-described composition, the solid wire for gas shielded arc welding of the present invention exhibited superior rust resistance and wire feedability to those of the conventional solid wires.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A solid wire for gas shielded arc welding treated with a surface treatment oil comprising: metal salts containing Sodium (Na), potassium (K), calcium (Ca) and zinc (Zn), and a non-metal phosphorus (P), and a hydrocarbon compound containing at least two functional groups selected from the group that consists of ester, carboxylic acid and alkane groups.

2. The solid wire according to claim 1, wherein, if converted into metal elements, respectively, the surface treatment oil comprises metal salts containing 0.05-0.85 wt % of Na+Ca, 0.05-0.70 wt % of K and 0.02-0.55 wt % of Zn, and 0.10-0.80 wt % of P, and 97.10-99.78 wt % of the hydrocarbon compound containing at least two functional groups selected from the group that consists of ester, carboxylic acid and alkane groups, with respect to a total weight of the surface treatment oil.

3. The solid wire according to claim 1 or claim 2, wherein the surface treatment oil is applied to the wire surface in an amount of 0.03-0.60 g per 1 kg of a wire for welding.
